(19) United States
(12) Patent Application Publication
(10) Pub. No.: US 2007/0276562 A1
(43) Pub. Date: Nov. 29, 2007

(54) Determination Of The Absolute Angular Position Of A Steering Wheel By Binary Sequences Discrimination

(75) Inventors: Pascal Desbiolles, Thorens-Gliéres (FR); Christophe Duret, Quintal (FR)

Correspondence Address: ARENT FOX LLP, 1050 CONNECTICUT AVENUE, N.W., SUITE 400, WASHINGTON, DC, 20036, US

(73) Assignee: S.N.R. ROULEMENTS, Annecy (FR)

(21) Appl. No.: 10/560,108

(22) PCT Filed: Jun. 10, 2004
(86) PCT No.: PCT/FR04/01455

§ 371 Date: Mar. 9, 2007

(30) Foreign Application Priority Data
Jun. 11, 2003 (FR) 03/07002
Jun. 11, 2003 (FR) 03/07000

(51) Int. Cl. G01C 25/00; G01F 15/14; G06F 7/00

(52) U.S. Cl. 701/36; 73/1.75; 73/432.1

(57) ABSTRACT

The invention relates to a method for determining the absolute angular position θ of a steering wheel (2) of a motor vehicle with respect to the chassis thereof comprising an initial procedure for determining whether a detected binary sequence is non-repetitive and, if yes, to test whether an estimate makes it possible to discriminate the absolute angular position of a encoder (1) in the case when the binary sequence is non-repetitive on a sector and to discriminate the absolute angular position of the steering wheel (2) θ₂ corresponding to said non-repetitive binary sequence; if no, to test whether an estimate makes it possible to discriminate the absolute angular position θ₃ of the steering wheel corresponding to said binary sequence.

The invention relates to a method for determining the absolute angular position of the steering wheel of a motor vehicle with regard to the chassis of said vehicle.

In many applications, mainly such as integrated chassis control systems and electrical power steering systems, it is necessary to know the absolute angular position of the steering wheel with regard to the chassis.

By absolute angular position we refer to the angle that separates the position of the steering wheel, at any given time, from a reference position, this reference position being fixed and provided with regard to the chassis.

On the other hand, the relative angular position is the angle that separates the position of the steering wheel from any initial position whatsoever and is variable with regard to the chassis.

To determine the absolute angular position of the steering wheel, there is a known way of using the measurement of the differential speed of the wheels on the same axle. In fact, it is possible to establish a bijective relationship between this differential speed and the angular position since, when the vehicle is following a straight or curved trajectory, each of the wheels has a trajectory with an identical centre of curvature. One of the problems that appear is that the absolute angular position is thus obtained with mediocre precision, which depends on the driving conditions of the vehicle.

Furthermore, there are known devices for incremental measurement of the angular position of the steering wheel that make it possible to obtain the relative angular position of the steering wheel with high levels of precision. However, to obtain the absolute angular position, it then becomes necessary to contemplate the determination of at least one reference position. Such a strategy is, for example, described in document EP-1,167,927. One limitation of these devices is that the detection of the reference angular position is only possible once per revolution, which, in certain driving conditions, may lead to the absolute angular position being determined only after a considerable amount of time and, therefore, distance traveled by the vehicle.

Finally, we know from document FR-0212013, not published at the time of submitting this application, a system for determining the absolute angular position of the steering wheel, which includes:
an encoder intended to be set in rotation together with the steering wheel, said encoder including a main multipolar track and a so-called “top turn” multipolar track which are concentric, said top turn track including M angularly distributed singularities;
a fixed sensor placed with respect to and at a gap distance from the encoder, including an electronic circuit that is able to emit two squared position signals A, B in quadrature, which represent the angular position of the encoder, and a top turn signal C in the form of M pulses per revolution of the encoder, in which the M singularities are distributed angularly so that the top turn signal C is arranged for, in combination with the signals A and B, defining a binary pattern including unique binary sequences that each represent at least one absolute angular position of the encoder;
a device for processing the signals A, B, C, which includes counting means that can determine, from an initial position, the variations of the angular position of the encoder; and
a device for analysing the differential speed of the wheels on the same axle of the vehicle, which can determine an estimate of the absolute angular position of the steering wheel according to said differential speed.

The aim of this document is, by means of detecting a unique binary sequence, to realign the relative angular position that results from the signals A and B in order to obtain the absolute angular position.

One restriction of this use of the system is that the realignment is carried out after detecting a complete unique binary sequence, which requires a sufficiently considerable rotation of the steering wheel, typically comprised between 30° and 75° from the initial position. Consequently, this leaves driving situations in which the alignment is not carried out fast enough. This is particularly the case when starting up the vehicle in a straight line, when there is a power-line disruption in the logic controller at high speed (100-130 km/h on the motorway, for example), or when starting up the vehicle on a bend with a very wide radius of curvature that does not require rotation of the steering wheel of any more than +/−20°, for example.

The invention aims to solve the limitations mentioned above mainly by providing a method for determining the absolute angular position of the steering wheel that makes it possible, under any driving conditions, to determine said position faster and with optimum precision.

For this purpose, the invention provides a method for determining the absolute angular position θ of the steering wheel of a motor vehicle with regard to the chassis of said vehicle, by means of a system including:
an encoder placed in rotation together with the steering wheel, said encoder including a main multipolar track and a so-called “top turn” multipolar track (1b), which are concentric, said top turn track including M angularly distributed singularities;
a fixed sensor placed with regard to and at a gap distance from the encoder, including an electronic circuit that is able to emit two squared digital position signals A, B in quadrature, which represent the angular position of the encoder, and a top turn signal C in the form of M pulses per revolution of the encoder, in which the relevant M singularities are distributed angularly so that the top turn signal C is arranged for, in combination with the signals A and B, defining a binary pattern including unique binary sequences in a revolution or a sector of a revolution, which each represent at least one absolute angular position of the encoder in the revolution or sector;
a device for processing the signals A, B, C, which includes counting means that can determine, from an initial position, the variations of the angular position of the encoder;
a device for analysing the differential speed of the wheels on the same axle of the vehicle, which can determine an estimate of the absolute angular position of the steering wheel according to said differential speed;
   said method including the initial process that contemplates the following:
determining at least one estimate θ* of the absolute angular position of the steering wheel by means of the analysis device;
creating the binary sequence that corresponds to the emitted signals A, B, C;
determining whether the binary sequence is unique;
if so, testing whether an estimate θ* makes it possible to discriminate the absolute angular position of the encoder in the case of the binary sequence being unique in a sector and to discriminate the absolute angular position of the steering wheel θ₂ that corresponds to the unique binary sequence;
if not, testing whether an estimate θ* makes it possible to discriminate the absolute angular position θ₃ of the steering wheel
that corresponds to the binary sequence;

In which an estimate θ* is used as an absolute angular position θ before determining the angular positions θ₂ and θ₃ and then, when one of the angular positions θ₂ or θ₃ is available, said angular position is used as an initial angular position θ₀ so as to determine, based on this initial position, the variations of the absolute angular position θ by means of the signals A, B.

Further objectives and advantages of the invention will become apparent in the following description, made in reference to the appended diagrams, in which:

FIG. 1 is a frontal view of the encoder of a determination system that can be used according to the invention, said encoder including a main multipolar track and a top turn multipolar track;

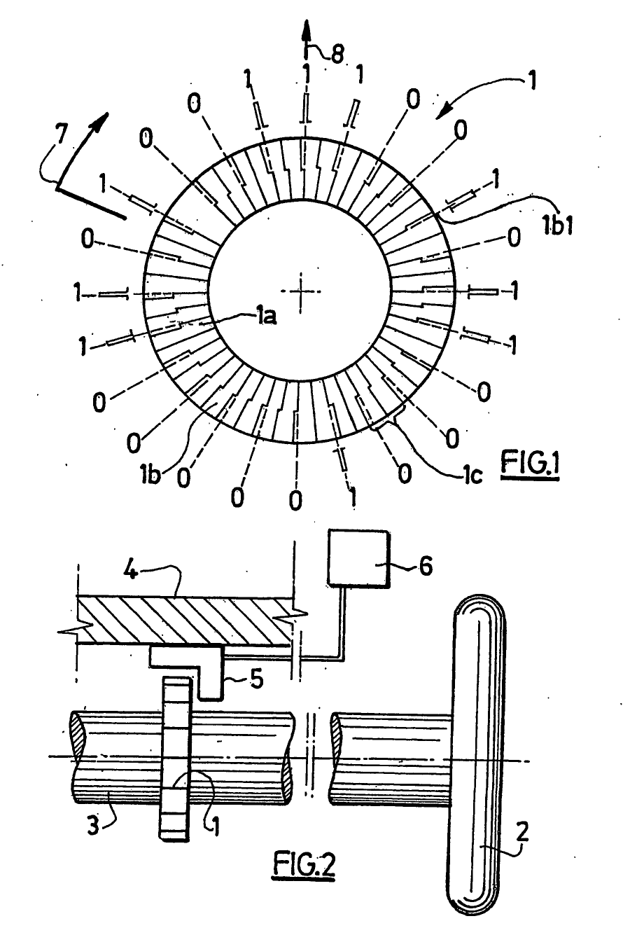

FIG. 2 is a diagrammatic and partial view of a steering system for a motor vehicle, which is equipped with a device for determining the absolute angular position of the steering wheel;

FIG. 3 shows the algorithm of an embodiment of the initial process in a determining method according to the invention;

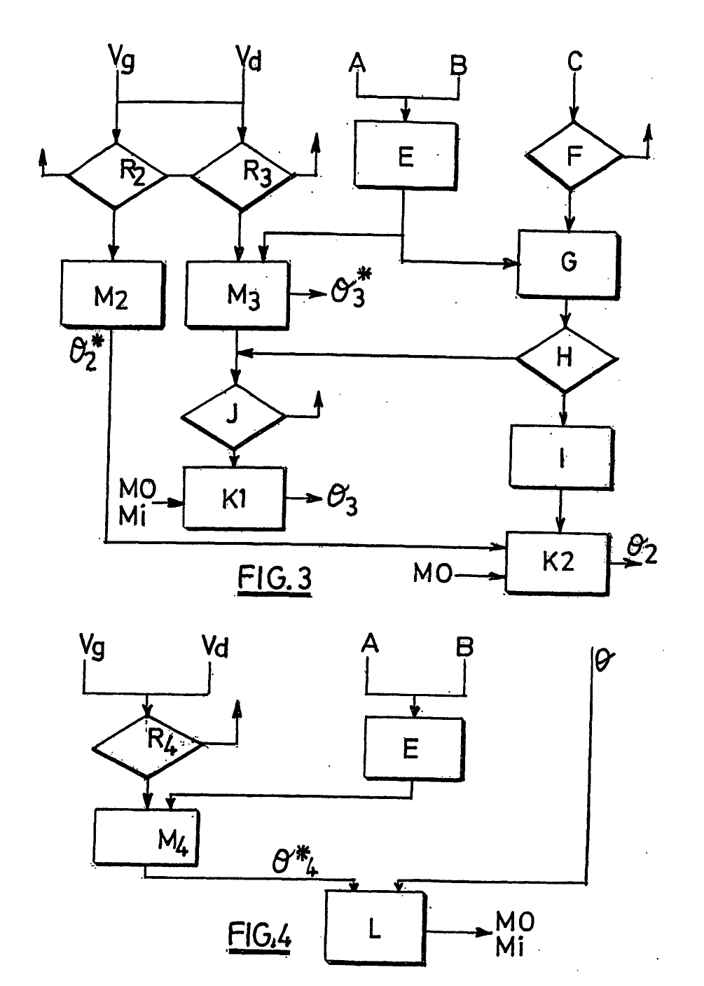

FIG. 4 shows the algorithm of an embodiment of the calibration process that can be used in a method according to the invention.

The invention relates to a method for determining the absolute angular position θ of the steering wheel 2 of a motor vehicle with regard to the chassis of said vehicle by means of a system including an encoder 1 set in joint rotation with the steering wheel 2 and a fixed sensor 5 that is able to detect the impulses emitted by the encoder 1. The method can be implemented in a host logic controller provided for this purpose, installed in a dedicated logic controller of the vehicle, or built into the sensor.

With regard to FIG. 2, a steering system is described including a steering column 3 on which an encoder 1 as shown in FIG. 1 is mounted, so as to assure the solidity in rotation of the column 3 and the encoder 1. In a known fashion, the column 3 is associated with the steering wheel 2, by means of which the driver applies a torque and thus a steering lock angle. Furthermore, the column 3 is arranged so as to transmit the steering lock angle to the turning wheels of the vehicle. For this purpose, the wheels may be mechanically linked to the column 3 by means of a rack and pinion so as to transform the rotation movement of the steering column 3 into angular displacement of the wheels, or may be decoupled from the column 3. In this latter case, the encoder 1 can be directly associated with a part of the steering wheel 2.

The steering wheel 2 is arranged so as to be able to make several turns, typically two, on either side of the “straight line” position in which the wheels are straight.

The steering system also includes a fixed element 4 solidly attached to the chassis of the motor vehicle, the sensor 5 being associated with said element so that the sensitive elements of the sensor are arranged with respect to and at a gap distance from the encoder 1.

In order to determine the absolute angular position of the encoder 1, and thus of the steering wheel 2, with respect to the fixed element 4, and therefore with respect to the chassis, the encoder 1 includes a main multipolar track 1a and a so-called “top turn” multipolar track 1b, which are concentric. The top turn track 1b includes M (where M>1) angularly distributed singularities 1b1.

In a particular example, the encoder 1 is formed by a magnetic multipolar ring on which multiple pairs 1c of north and south poles are magnetised and evenly distributed with a constant angle width so as to form the main track 1a and the top turn track 1b, a magnetic singularity 1b1 of the top turn track 1b being formed by two adjacent poles, where the magnetic transition is different from the others.

According to the embodiment shown in FIG. 1, the main track 1a, arranged toward the inside of the ring, and the top turn track 1b, arranged toward the outside of the ring, include 24 pairs of poles 1c, the pairs of poles 1c of the top turn track 1b having a phase lag with a value [symbol] with respect to those of the main track 1a.

Each singularity 1b1 is formed by a pair of poles 1c, the width of the poles being arranged so that a pole is out of phase by [symbol] with respect to the corresponding pole of the main track 1a. Thus, each signal pulse C corresponds to detection of the phase lag reversal between the main track 1a and the top turn track 1b.

Moreover, the sensor 5 includes an electronic circuit with at least three sensitive elements, at least two of which are positioned with respect to the main track 1a and at least one of which is positioned with respect to the top turn track 1b.

In a particular example, the sensitive elements are chosen from the group including Hall-effect probes, magnetoresistances and giant magnetoresistances.

The sensor 5 used is capable of delivering two periodic electrical signals S1, S2 in quadrature by means of the sensitive elements arranged with regard to the main track 1a and an electrical signal S3 by means of the sensitive elements arranged with regard to the top turn track 1b.

The principle for obtaining the signals S1 and S2 from a multitude of aligned sensitive elements is described for example in document FR-2,792,403, issued by the applicant.

But sensors 5 including sensitive elements which are capable of delivering the signals S1 and S2 are also known.

Based on the signals S1, S2 and S3, the electronic circuit is able to deliver squared digital position signals A, B in quadrature and a top turn signal C in the form of M electrical pulses per revolution of the encoder.

A principle for obtaining the digital signals A, B and C, as well as the different modes of implementation of the magnetic singularities 1b1 are described in the documents FR-2,769,088 and EP-0,871,014.

According to an embodiment of the invention, the electronic circuit also includes an interpolator, for example of the type described in document FR-2,754,063 by the applicant, allowing the resolution of the output signal to be increased. In particular, a resolution of less than 1° of the angular position of the encoder 1 can be obtained.

The sensor 5 may be incorporated on a silicon substrate or similar, for example AsGa, so as to form an integrated circuit that is customised for a specific application, a circuit sometimes denoted under the term ASIC to refer to an integrated circuit designed entirely or partially according to its specific purpose.

Although the description is made with regard to a magnetic encoder/sensor assembly, it is also possible to implement the invention in an analogous fashion using an optical sensor. For example, the encoder 1 can be formed by a metal or a glass tracking pattern on which the main track 1a and the top turn track 1b are engraved so as to form an optical pattern that is analogous to the multipolar magnetic pattern stated above, the sensitive elements then being formed by optical detectors.

The determination system also includes a processing device 6 for the signals A, B, C which includes counting means that are capable of determining, from the initial position, the variations of the angular position of the encoder 1. In an example of an embodiment of the invention, the counting means include a register in which the value of the angular position is increased or reduced according to the number of wavefronts of the signals A and B detected, the initial value being fixed, for example, at zero on commissioning the system. Thus, the processing device makes it possible to determine the relative position of the encoder 1 with regard to the initial position.

The determination system also includes a device for analysing the differential speed of the wheels on the same axle of the vehicle, which is able to determine an estimate of the absolute angular position of the steering wheel 2 according to said differential speed.

In order to obtain the absolute angular position of the steering wheel 2, it has been contemplated to use an encoder 1 with a specific distribution of the singularities 1b1 of the top turn track 1b.

In the embodiment of the invention shown in FIG. 1, the angular distribution of the ten singularities 1b1 of the top turn track 1b can be represented by the binary pattern 000001000110100111001011 obtained by using the signal C and the signals A and B upon the rotation of one revolution, where the number 1 corresponds to the detection of a top turn impulse on the pair of poles that correspond to the singularity 1b1 and the number 0 represents the absence of such detection.

With this binary pattern, it is possible to establish, according to the initial position of the encoder 1 and the direction of rotation, the number of 0 or 1 states to be read so as to determine the position of the encoder 1 in an unequivocal fashion on one revolution. This succession of 0's and 1's that makes it possible to determine an absolute position of the encoder 1 on one revolution, is called a unique binary sequence in the rest of the description.

Consequently, the M singularities 1b1 are angularly distributed over the encoder 1 so that the signal C can be arranged, in combination with the signals A and B, to define unique binary sequences that each represent an absolute angular position of the encoder 1 on one revolution. In particular, this absolute angular position can be defined with respect to the “straight line” position of the encoder (arrow 8), which corresponds to an angular position equal to 0°.

In an alternative embodiment, not shown, it can be foreseen for the binary pattern to include turn sectors each provided with unique binary sequences such as defined previously. Consequently, these unique binary sequences each represent an absolute angular position of the encoder 1 in the relevant sector.

The determining method according to the invention provides an initial process in which at least an estimate 0 of the absolute angular position of the steering wheel 2 is determined by means of the analysis device.

In order to do this, with the supposition that the friction between the ground and the wheels is negligible, there is a bijective relationship between the angular position θ* and the differential speed of the wheels. This friction is particularly negligible when the measurement of the differential speed is taken on the non-drive wheels, but also on the drive wheels when there is normal adherence. According to an embodiment, the relationship is identified with the help of measurements taken on the vehicle in optimum conditions that can include:
movement of a vehicle across a flat area;
stable vehicle speed;
slow turning of the steering wheel;
nominal tyre pressure;
dry ground.

In these conditions, it is possible to establish the polynomial relationship, for example of order three, that makes it possible to estimate the angular position θ* according to the differential speed. By using this relationship inside the analysis device it is possible, at any time, to obtain an estimate [symbol] * of the angular position θ according to the measured differential speed. For this purpose, the respective speeds of the left V_{g} and right V_{d} wheels on the same axle are input into the analysis device, which includes calculation means arranged to provide the differential speed.

In the algorithm shown in FIG. 3, the determination of two estimates is contemplated: a rough estimate θ*₂ and a fine estimate θ*₃, which are respectively obtained when certain driving conditions R₂, R₃ are respected. The rough estimate θ*₂ is typically used to determine the rotation or sector of rotation in which the steering wheel is located, and the fine estimate θ*₃ is used to determine the absolute angular position of the steering wheel before a unique binary sequence is completely created. However, the process can be implemented using a single estimate θ* that has sufficient precision for determining the angular positions θ₂ and θ₃ as described below.

The initial process also contemplates, by counting the variations in the angular position of the encoder 1 (step E) and detecting the top turns (step F), the creation of the binary sequence that corresponds to the delivered signals A, B, C (step G). For example, starting at the position indicated by the arrow 7 in FIG. 1, the sequence created is 1 then 10 then 100 then 1001 then 10011, the latter being unique in the binary pattern. The angular position represented by the arrow 8 in FIG. 1 is the absolute angular position of the encoder corresponding to this unique binary sequence.

The method contemplates determining if the created binary sequence is unique (test H).

When the created sequence is unique, the absolute angular position of the encoder is known (step I) and the angular position of the steering wheel θ₂ can be known (step K₂) thanks to the estimate θ*₂ (step M₂) as soon as there is enough precision to make it possible to discriminate the revolution, or possibly the revolution sector, in which the sequence is unique. In the example stated above, the binary sequence 10011 makes it possible to determine the “straight line” position as an absolute position on the revolution in which the measurement was taken, and as soon as the precision of the estimate θ*₂ is less than +/−180° it is possible to discriminate the position between −720°, −360°, 0°, 360° or 720° (in the case that the steering wheel 2 is arranged to turn +/−2 complete turns). The driving conditions R₂ for determining θ*₂ are therefore planned for achieving this precision, for example a vehicle speed higher than 2 km/h and a displacement time greater than 400 ms enable obtaining a typical precision of around +/−50°.

In the case in which the created sequence is not unique, the initial process contemplates testing (test J) whether the estimate θ₃ enables discriminating the absolute angular position θ₃ of the steering wheel that corresponds to the binary sequence. If the created binary sequence is 001, which occurs four times in the pattern (−105°, −15°, 60°, 165°), one of the occurrences is validated (step K₁) as soon as the precision of the estimate θ*₃ allows, for example when θ*₃=520°+/−15°, the occurrence 1650 is validated and θ*3=515°.

In an embodiment of the invention, the fine estimate θ*₃ is obtained by repeated determination of the average difference between the angular positions measured from the signals A, B (step E) and the angular positions calculated from the differential speed of the wheels, adding said difference to the angular position measured from the signals (A, B) (step M₃). In fact, this mobile point-to-point average makes it possible, in driving conditions R₃ such as vehicle speed higher than 5 km/h and steering-wheel speed lower than 20°/s, to obtain θ*₃ with a precision lower than +/−15° after two seconds. This method for determining θ*3 is described in French patent application FR-0307002, and its general principle is recalled below.

In this method, the angular position δ(tᵢ) measured from the signals A, B as well as the differential speed ΔV/V(tᵢ) are sampled, for example, for a period of approximately 1 ms.

An estimate θ*(tᵢ) of the angular position of the steering wheel is determined by means of the calculation for each measurement of the differential speed ΔV/V(tᵢ), for example, by means of a bijective relationship such as mentioned previously.

The incremental angular position δ(tᵢ) makes it possible to know the variations in the angular position θ(tᵢ) over time, but it is shifted by a constant offset value with respect to the said absolute angular position.

The method according to this embodiment of the invention proposes calculating this value by foreseeing, for example at every tₙ instant, to determine the difference of the average of the vectors \hat{θ}*(tₙ)=[θ*(t₀) . . . θ*(tₙ)] and \hat{δ}(tₙ)=[δ(t₀), . . . δ(tₙ)] so as to obtain the average offset(tₙ) difference. In fact, the offset(tₙ) value then corresponds to the minimum of the cost function \hat{θ}*(tₙ)−\hat{δ}(tₙ)−offset*lₙ, lₙ being the identity matrix of the dimension n.

Thus, the method proposes to use all the θ* (tₙ) and δ(tₙ) values in a statistical fashion so as to continuously improve the accuracy of the average offset(tₙ) since the number of values used increases over time. Moreover, it may be supposed that all the disruptions that affect the calculation of the estimates θ*(tₙ), for example such as uneven ground, are centred on zero, the proposed statistical calculation making it possible to rapidly converge towards the sought offset value.

Consequently, by adding the average offset(tₙ) difference and the angular position δ(tₙ), the estimate θ*₃(tₙ) of the absolute angular position of the steering wheel 2 can be obtained repeatedly, overcoming most of the faults in the driving area.

According to an embodiment of the invention, the accuracy in the determination of the absolute angular position can be improved by planning to implement this process under specific driving conditions. For example, as mentioned above, the driving conditions R₃ can include a maximum rotation speed of the steering wheel so as to restrict the disruptions linked to the delay in the vehicle coming in line with the trajectory and/or a minimum speed of the vehicle in order to enable an improvement of the accuracy of the estimates. As a numerical example, the speed limit of the vehicle may be set at 5 km/h and the speed limit of the steering wheel at 20°/s. Thus, if these conditions are met for at least 2 seconds, not necessarily consecutively, it is possible to obtain an estimate [symbol] *₃ with a typical precision of around +/−5°. This precision can therefore be obtained after driving for 25 m and can be established to within +/−2° after driving for 50 m.

Furthermore, the calculation of the estimate θ*₃ according to this embodiment makes it possible to overcome the mechanical indexing faults between the encoder 1 and the steering wheel 2, since these are corrected when calculating the offset value.

Based on the initial process, the determination process contemplates using an estimate θ*, in particular θ*₃, as an absolute angular position θ before determining the angular positions θ₂ and θ₃. This information, although less precise, has the advantage of being very readily available. In addition, since the driving conditions R₂ are less severe than those provided in R₃, the estimate θ*₂ will be available before the estimate θ*₃. Then, when one of the angular positions θ₂ or θ₃ is available, the said angular position is used as an initial angular position θ₀. In this way, the variations of the absolute angular position θ are determined from this initial position by means of the signals A, B so as to know, continuously, the said position thanks to the counting means.

The method therefore contemplates using the first available information out of θ₂ and θ₃, which makes it possible, under all driving conditions, to rapidly obtain a precise absolute angular position θ. In particular, the absolute angular position of the steering wheel is available before the 15 km/h threshold, beyond which the integrated chassis control system is required. Moreover, it should be noted that the precision of the estimates θ*₂ and θ*₃ improves with driving time and that they make it possible to overcome, for the most part, the influence of the road profile (potholes, bumps) on the speed of the wheels.

In a diagrammatic fashion, we can study two classic scenarios:
the vehicle starts up, runs and the driver turns the steering wheel sufficiently: [symbol] ₂ is available before θ₃;
the vehicle starts, runs and the driver turns the steering wheel only slightly (around +/−7.5°, for example): θ₃ is available before θ₂.

As a variant, the method also contemplates, when the angular position θ₀ is based on the angular position θ₃, realigning the angular positions θ determined subsequently according to the angular position θ₂ when this position is available, so as to improve the reliability of the obtained angular positions.

The initial process described above is mainly intended to be used when starting or restarting the determination system so as to realign the relative angular position that results from the signals A, B. Moreover, this process can be used repeatedly after the realignment in order to increase the reliability of the determination method. Furthermore, it can also be provided for the method to use other dynamic ways to estimate the angular position of the steering wheel, such as a bend sensor, an accelerometer or a gyroscope, to speed up, check and/or increase the reliability of the calculations made.

According to an embodiment of the invention, the method also includes a calibration process (see FIG. 4) in which, prior to using the determination system, the angular position of the encoder is electronically indexed with respect to the angular position of the steering wheel. In particular, the shifting of the “straight-line” position 8 of the encoder with respect to the “straight-line” position of the wheels of the vehicle can be determined. This process makes it possible to cancel the angular positioning errors of the encoder when it is mounted on the vehicle, and thus to do away with precise mechanical indexing of the encoder with respect to the angular position of the wheels.

The calibration process contemplates determining an estimate θ*₄ of the absolute angular position of the steering wheel by means of an analysis device under specific driving conditions R₄ that are more severe in terms of time and speeds than those used to determine θ*₂ and θ*₃. For example, the driving conditions may impose a range of angular positions of the steering wheel around the “straight-line” position (for example +/−45° around the straight line). In these conditions, it is possible to obtain, for example by using the same calculation method (step M₄) as that described above for determining θ*₃, the angular position θ*₄ with a precision of +/−2°. Consequently, the estimate θ*₄ is available less rapidly than the other estimates. As a variant, depending on the desired calibration precision, the estimate θ*₃ can be used instead of the estimate θ*₄.

Then, the estimate θ*₄ is compared (step L) with the absolute angular position [symbol] defined by the methods described previously, so as to deduce the angular shift M₀ between the encoder and the steering wheel. In fact, the estimate θ*₄ is independent from the mounting of the encoder and depends on the heading of the vehicle, while the absolute angle θ determined according to θ*₂ or θ*₃ depends on the mounting of the encoder. Consequently, inaccurate mounting of the encoder that results in a shift between the straight-line position of the encoder and the heading of the relevant vehicle, typically but not exhaustively comprised between +/−15°, can be corrected so as to cancel out this shift. This indexing can be performed at the end of the production chain or during a maintenance operation, where the value M₀ can be memorised so as to be used for determining the initial angular position θ₀ to correct the estimates θ*₂ and θ*₃ obtained. As a variant, the calibration process can be carried out several times, so as, by means of the values of M₀ obtained, to increase the reliability of the indexing performed.

According to an embodiment of the invention, the calibration process can be carried out repeatedly so as to obtain angular shifts Mᵢ that are used as they are obtained to determine the initial angular position θ₀ in an updated fashion according to the driving conditions and the characteristics of the vehicle. Thus, even in the case of a fault relating to a wheel or to an axle system (such as a variation in the pressure of the tyre, axle adjustment), it is possible to determine the angles θ₂ and θ₃ in a reliable manner.

According to an embodiment of the invention, the method according to the invention also contemplates determining the difference between M₀ and Mᵢ and, if this difference is above a certain threshold, to deduce the existence of a fault linked with a wheel. In fact, if one of the tyres is punctured, flat or if a wheel with a different diameter is installed, this results in a drift of the values of Mᵢ and in the difference [M₀−Mᵢ] rising above a threshold that enables the detection of these events. This determination of a fault linked with a wheel can be refined if necessary by filtering the values Mᵢ, detecting a slow or fast drift, calculating when starting the vehicle or during a stable driving phase.

As a variant, the method contemplates determining the sign of the difference between M₀ and Mᵢ so as to deduce the wheel affected by the fault. In particular, in the case of a puncture, if M₀−Mᵢ>0 the right wheel is affected. The left wheel is affected if the opposite is true.

1. A method for determining the absolute angular position θ of the steering wheel (2) of a motor vehicle with respect to the chassis of said vehicle, by means of a system including:
an encoder (1) set in rotation together with the steering wheel (2), said encoder including a main multipolar track (1a) and a so-called “top turn” multipolar track (1b), which are concentric, said top turn track including M angularly distributed singularities (1b1);
a fixed sensor (5) placed with respect to and at a gap distance from the encoder (1), including an electronic circuit that is able to emit two squared digital position signals (A, B) in quadrature, which represent the angular position of the encoder (1) and a top turn signal (C) in the form of M pulses per revolution of the encoder (1), in which the relevant M singularities (1b1) are distributed angularly so that the top turn signal (C) is arranged for, in combination with the signals A and B, defining a binary pattern including unique binary sequences in a revolution or a sector of a revolution, which each represent at least one absolute angular position of the encoder (1) in the revolution or sector;
a device (6) for processing the signals (A, B, C), which includes counting means that can determine, from an initial position, the variations of the angular position of the encoder (1);
a device for analysing the differential speed of the wheels on the same axle of the vehicle, which can determine an estimate of the absolute angular position of the steering wheel (2) according to said differential speed;
Said method including the initial process that contemplates the following:
determining at least one estimate θ* of the absolute angular position of the steering wheel (2) by means of the analysis device;
creating the binary sequence that corresponds to the emitted signals (A, B, C);
determining whether the binary sequence is unique;
if so, testing whether an estimate θ* makes it possible to discriminate the absolute angular position of the encoder (1) in the case of the binary sequence being unique in a sector and to discriminate the absolute angular position of the steering wheel (2) θ₂ that corresponds to the unique binary sequence;
if not, testing whether an estimate θ* makes it possible to discriminate the absolute angular position θ₃ of the steering wheel (2) that corresponds to the binary sequence;
In which an estimate θ* is used as an absolute angular position [symbol] before determining the angular positions θ₂ and θ₃ and then, when one of the angular positions θ₂ or θ₃ is available, said angular position is used as an initial angular position θ₀ so as to determine, based on this initial position, the variations of the absolute angular position θ by means of the signals (A, B).

2. A method according to claim 1, characterised in that it also contemplates, when the angular position θ₀ is based on the angular position θ₃, to realign the angular positions θ determined subsequently according to the angular position θ₂ when it is available.

3. A method according to claim 1 or 2, characterised in that the determination of the estimate θ* is implemented under set driving conditions.

4. A method according to claim 3, characterised in that it contemplates determining two estimates θ*₂ and θ*₃ according to respective set driving conditions, the rough estimate θ*₂ being used to discriminate the angular position θ₂ and the fine estimate θ*₃ being used to discriminate the angular position θ*₃.

5. A method according to claim 4, characterised in that the fine estimate θ*₃ is obtained by repeated determination of the average difference between the angular positions measured based on the signals (A, B) and the angular positions calculated according to the differential speed of the wheels, and by adding the said difference to the angular position measured according to the signals (A, B).

6. A method according to any one of the claims from 1 to 5, characterised in that the measurement of the differential speed is carried out on the non-drive wheels.

7. A method according to any one of the claims from 1 to 6, characterised in that it includes a calibration process in which, under particular driving conditions:
an estimate θ*₄ of the absolute angular position of the steering wheel (2) is determined by means of the analysis device;
the estimate θ*₄ is compared with the absolute angular position θ determined so as to then deduce from it the angular shift (M₀) between the encoder (1) and the steering wheel (2).

8. A method according to claim 7, characterised in that the calibration process is carried out repeatedly so as to obtain the angular shifts (Mᵢ).

9. A method according to claim 7 or 8, characterised in that the shift (M₀) or shifts (Mᵢ) are used when determining the initial angular position 90.

10. A method according to claim 7 or 8, characterised in that it contemplates determining the difference between M₀ and Mᵢ and, if the difference is greater than a threshold, deducing that there is a fault linked with a wheel.

11. A method according to claim 10, characterised in that it contemplates determining the sign of the difference between M₀ and Mᵢ, so as to deduce the wheel affected by the fault.
